(19) United States
(12) Patent Application Publication
(10) Pub. No.: US 2026/0225744 A1
(43) Pub. Date: Aug. 6, 2026

(54) SYSTEM, METHOD FOR OPERATING A SYSTEM, AND USE

(71) Applicant: HAVER & BOECKER OHG, Oelde (DE)

(72) Inventor: Dirk BERGMANN, Ostbevern (DE)

(21) Appl. No.: 19/150,364

(22) PCT Filed: Jan. 25, 2024
(86) PCT No.: PCT/EP2024/051712

§ 371 Date: Jul. 23, 2025

(30) Foreign Application Priority Data
Jan. 31, 2023 (DE) 102023102321.7
Feb. 15, 2023 (DE) 102023103663.7

(51) Int. Cl. B65B 1/30; B65B 57/02; G06T 7/00; G06V 10/82; G06V 20/52

(52) U.S. Cl. CPC B65B 1/30; B65B 57/02; G06T 7/0004; G06V 10/82; G06V 20/52; G06T 2207/20081; G06T 2207/20084; G06T 2207/30232; G06V 2201/06

(57) ABSTRACT

A system including a packing machine, a control device and a monitoring device, the monitoring device includes at least one sensor device and one computing device and the machine includes a filling module with a filling spout. The computing device checks data collected by the sensor device to predetermined conditions with the aid of an evaluation based on an automated application. The automated application has at least one of an AI application and a computer vision application. In the method for operating such a system, it is concluded that there is a specific event based on the evaluation of the data from the sensor device on the basis of the automated application and a correspondingly predetermined action is initiated. Also disclosed is the use of an automated application having at least one of an AI application and a computer vision application in the monitoring of events on a packaging machine.

The present invention relates to a system comprising at least one packaging machine, in particular for filling bulk materials, at least one control device and at least one monitoring device, wherein the monitoring device comprises at least one sensor device and at least one computing device. The packaging machine comprises at least one filling module with at least one filling spout. The present invention also relates to a method for operating such a system and its use.

Packaging machines, e.g. for filling bulk material into bags, are known in a wide variety of designs in the state of the art. For example, there are packaging machines with only one filling module with a filling spout, to which, depending on the design, an open-mouth bag, a valve bag and/or a big bag can be attached, for example. Depending on the design, however, a plurality of filling modules can also be arranged in row and there are also rotating packaging machines, in which a plurality of filling modules are arranged distributed over the circumference of the packaging machine, wherein bags attached to the filling spout(s) are then filled during the rotation of the packaging machine.

There are many automated processes in such packaging machines that monitor the filling process and the operation of the packaging machine in general. For example, the filling pressure can be used to check whether a bag is correctly attached to the filling spout and/or whether the bag has a leak or bursts or tears during the filling process. In the case of a leaking bag, more filling pressure than normal must be applied in order to maintain the desired filling pressure. Depending on the design, however, the sudden drop in pressure is also detected, e.g. in the case of a bursting bag, and/or the slower increase in the filling pressure in the case of a bag that is already leaking. Depending on the design, however, the leakage of a bag can also be detected by a weight gain that does not occur as expected.

However, the disadvantage of this illustrative monitoring is that detecting a leak on the basis of the filling pressure can sometimes take several seconds, e.g. 2 to 4 seconds, depending on the design. In this time interval from the occurrence of the leak to the detection of the leak, when filling cement on a high-performance machine for example, several kilograms of cement can be conveyed into the environment and not into the bag, which can lead to significant contamination and enormous dust generation. This needs to be improved.

The problem underlying the present invention, therefore, is to improve the monitoring of processes on a packaging machine, in particular the detection of malfunctions, or to accelerate the reaction time.

This problem is solved by a system with the features of claim 1, by a method with the features of claim 6 and by use with the features of claim 11. Preferred developments of the invention are the subject-matter of the sub-claims. Further advantages and features of the present inventions result from the general description and the description of the example of example of embodiment.

The system according to the invention comprises at least one packing machine, at least one control device and at least one monitoring device, wherein the control device comprises at least one sensor device and at least one computing device. The packaging machine comprises at least one filling module with at least one filling spout. The computing device is suitable and designed to check the data recorded by the sensor device with the aid of at least one evaluation based on at least one automated application on predetermined events.

The packaging machine is in particular a packaging machine for filling bulk goods and/or dusty, flowable and/or free-flowing products in general.

In particular, such a packaging machine can comprise at least one filling module with at least one filling spout. A plurality of filling modules can also be provided in a row. Depending on the design, however, the packaging machine can also be designed as a so-called rotating packaging machine with a plurality of filling spouts distributed over the circumference, so that, for example, a bag to be filled is attached to a filling spout at one position, and is filled during rotation and then ejected.

In particular, an automated application is at least a processor-based application or a computer-based application which processes, further processes or analyses the data detected by the sensor device.

According to the invention, the automated application is at least one AI application and/or at least one computer vision application and/or includes at least one of these applications.

Computer vision refers in particular to the analysis of images and videos with the aid of computer programs. The aim of these analyses is in particular the extraction of information contained in the image. Depending on the design, probabilistic methods are preferably used, methods of image processing, projective geometry, deep learning and computer graphics.

In the field of AI application, any application in the field of artificial intelligence can be used, which can be used advantageously for monitoring in relation to packaging machines. In particular, the use of machine learning (ML) is advantageous here, wherein such machine learning is a subfield of artificial intelligence (AI). A central component of machine learning is algorithms and methods that enable programs to learn from data without being explicitly programmed. Thus, these programs can preferably make decisions independently. In particular, a distinction is made between supervised, unsupervised and semi-supervised learning. The supervised learning methods include, amongst other things, convolutional neural networks (also referred to as space invariant artificial neural networks) and further developments of convolutional neural networks, such as region-based convolutional neural networks. These modifications of conventional neural networks are particularly suitable for image processing applications, since one or more pre-processing steps are carried out before the neural network, depending on the design, including convolution operations for example, depending on the application.

In particular, sensors (e.g. optical sensors such as a camera in colour or black and white, thermal imaging, . . . ) are used to record data of specific conditions (e.g. bag breakage). These images and their states are then brought into correlation by assigning the corresponding label to each state (an image=a matrix of information). This can be done directly through an interaction between the packaging machine and the monitoring device, e.g. if the packaging machine detects a bag leak via conventional inspection methods that the monitoring device itself has not detected. Here, a link is then made between the detected bag leakage and the corresponding image, which further trains the AI and makes the detection more reliable. A bag breakage or pure leakage detected by the monitoring device can also be used as a further data basis for teaching. Feedback learn and not feedback-learning.

This declared information is then preferably transferred/learned into a CNN (convolutional neural network) by machine learning or AI processes or AI applications.

If, for example, a sensor looks at the filling spout during a filling, the data are permanently routed through the CNN and the latter evaluates the status directly and the status is further processed by the packaging machine or the control device (dust detected =packaging machine stops the filling process).

For example, a sensor device can be a camera device and/or comprise one such, or depending on the design can also comprise an acoustic sensor, a temperature sensor and/or at least another suitable sensor, or be designed as such.

The system according to the invention offers many advantages. A significant advantage is that predetermined events can be detected much faster by the automated application based on the data collected by the sensor device than via conventional monitoring functions, depending on the design. This results from the fact that, on the basis of the data collected by the sensor device, a predetermined event can be detected extremely quickly via the automated application, irrespective of other operating procedures and operating parameters.

Preferably, the evaluation of the automated application can be transferred to the control device. This makes it possible for the control device to directly control or regulate the filling process of the packaging machine, for example when a predetermined event is detected.

In appropriate developments, the sensor device comprises at least one camera device. Depending on its design, such a camera device or camera can meet specific requirements. Depending on the design, a conventional webcam, for example, is sufficient. The image data from the camera device is then preferably used in the evaluation.

In appropriate designs, the sensor device is arranged upstream of or assigned to at least the filling module, wherein this is to be understood in particular that the detection area of the sensor device, for example a camera, can at least capture the filling spout.

Preferably, such a design can be used for example to monitor or check or detect whether a bag to be filled is correctly attached to a filling spout and/or whether a bag leakage is present and/or occurs during the filling process. However, grade recognition can preferably also be achieved based on the type of bag and it can be detected, for example, whether the valve is correctly opened when using valve bags. Depending on the design, it can also be seen whether a filled bag has been closed correctly. In particular, the correct closure of a valve bag and/or an open-mouth bag can be checked. The correct closure of a valve bag and/or an open-mouth bag can be detected in particular by evaluating conventional image data, preferably from a camera device, such as a conventional webcam, for example. This list of cases of application is only by way of example. This monitoring can also be carried out very quickly by the method according to the invention.

The method of the invention is suitable for operating a system as described above. Based on the evaluation of the data from the sensor device with the aid of the automated application, it is concluded that there is a specific event and a predetermined action is then initiated when a predetermined event is detected. The automated application is at least an AI application and/or at least a computer vision application and/or includes at least one of these applications.

The same definitions of artificial intelligence and computer vision apply here, as they were previously described for the system.

The method according to the invention also offers the advantages as they have already been explained for the system according to the invention.

The automated application preferably checks the data online. For example, a computational process can thus be executed decentrally on several computing stations or on an online computing application based on the data to determine a predetermined event.

The automated application is particularly preferable trained and/or can be used offline on the computing device. Depending on the design, the automated application can first be trained online in order to provide the broadest and largest possible computing power for training. Depending on the design, any further functionality and further learning can also take place locally.

The automated application is retrained in appropriate developments. This can take place online, offline or via other methods and procedures.

It is particularly preferable to detect the leakage of a bag during the filling process. Based on the detection of such an event, for example, the control device can stop the filling process. By using an automated application and, in particular, at least one AI application and/or at least one computer vision application, the time span from bag breakage to the shutdown of the packaging machine or the shutdown of the filling module or the filling process at the corresponding filling spout can for example be significantly shortened. With conventional methods, in which a bag breakage, for example, is detected due to the drop in the filling pressure of the packaging machine, the shutdown time can be reduced from several seconds to less than one second, preferably less than half a second, and in particular to less than e.g. 1/10 of a second.

By means of the method according to the invention, it can preferably and by way of example also be monitored or checked whether a bag to be filled is correctly attached to a filling spout, whether there is a bag leakage. However, it can also preferably be used for variety recognition based on the bag type (e.g. size, print image, material) and it can be detected, for example, whether the valve is correctly opened when valve bags are used. Depending on the design, it can also be seen whether a filled bag has been closed correctly. In particular, the correct closure of a valve bag and/or an open-mouth bag can be checked. The correct closure of a valve bag and/or an open-mouth bag can be detected in particular by evaluating conventional image data, preferably from a camera device such as a conventional webcam. This list of cases of application is only by way of example.

The use according to the invention relates to the use of an automated application, in particular an application comprising at least one AI application and/or at least one computer vision application, in the monitoring of events on a packaging machine.

The use according to the invention also offers the advantages as they have already been explained for the system and method according to the invention.

The events are preferably monitored based on image data from at least one camera device of at least one sensor device.

Preferably, a system is used as described earlier. In particular, all features according to the previously described system and/or method can also be integrated individually and/or combined into the use according to the invention.

Particularly preferably, the leakage of a bag (200) during filling is detected as an event and/or it is detected whether a bag (200) to be filled is correctly attached to the filling spout and/or it is recognised whether a filled bag (200) has been closed correctly and/or it is recognised which type of bag is being used for filling and/or whether the bag is correctly opened for attachment.

Further advantages and features of the present invention result from the example of embodiment, which is explained below with reference to the appended figures.

The figures show:

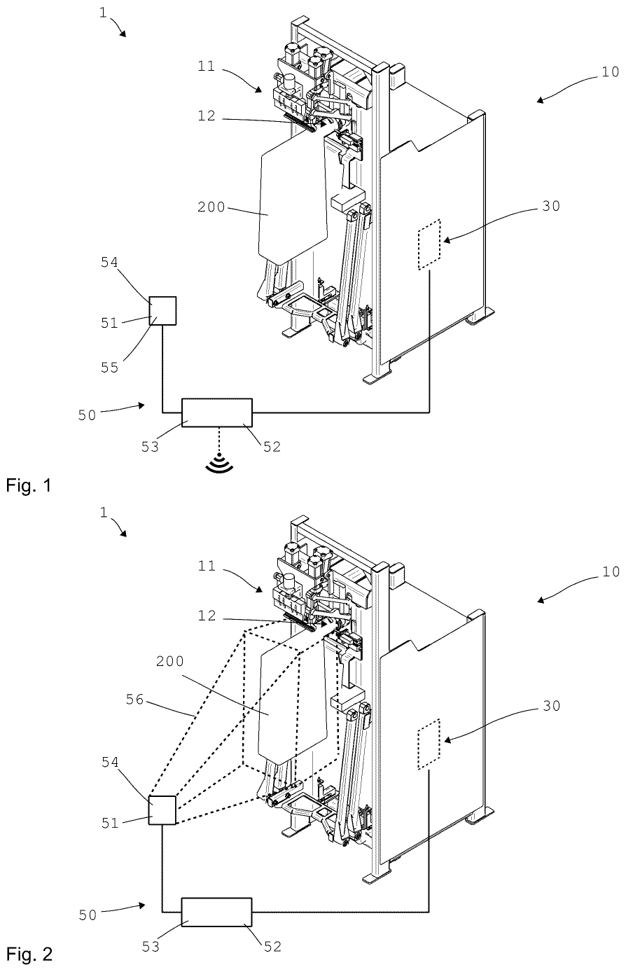

FIG. 1 a purely schematic representation of an example of embodiment of a system according to the invention in a perspective view;

FIG. 2 the example of embodiment according to FIG. 1 in a supplemented perspective view;

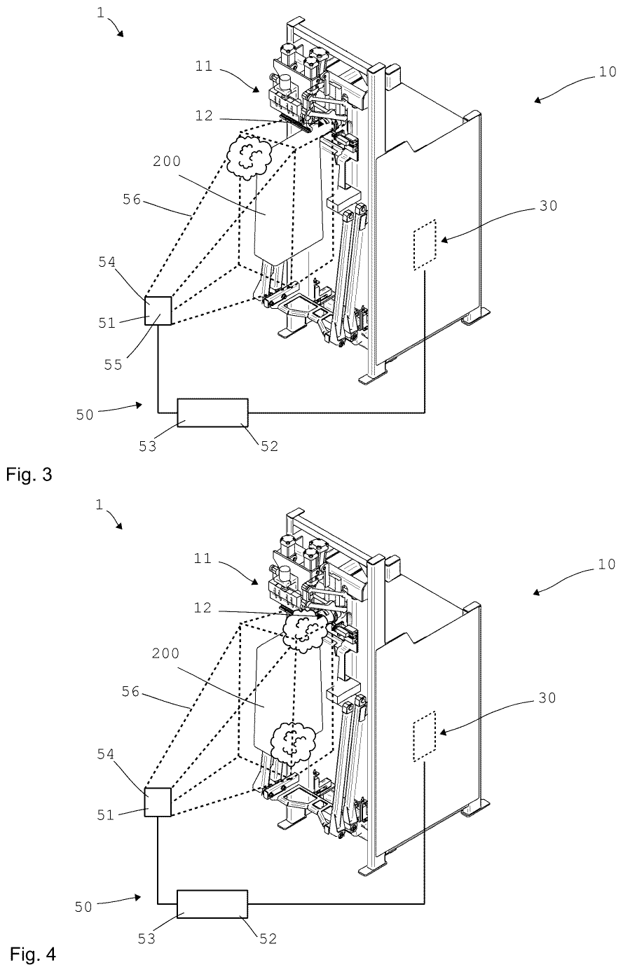

FIG. 3 the example of embodiment according to FIG. 1 in a further supplemented perspective view;

FIG. 4 the example of embodiment according to FIG. 1 in another supplemented perspective view;

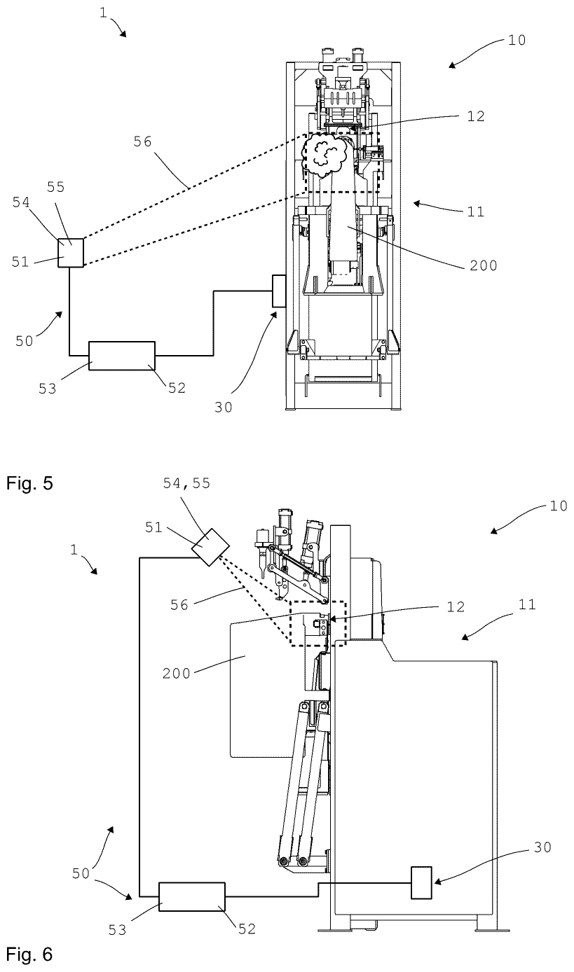

FIG. 5 a purely schematic representation of a further example of embodiment of a system according to the invention in a view from the front;

FIG. 6 a purely schematic representation of a next example of embodiment of a system according to the invention in a view from the side; and

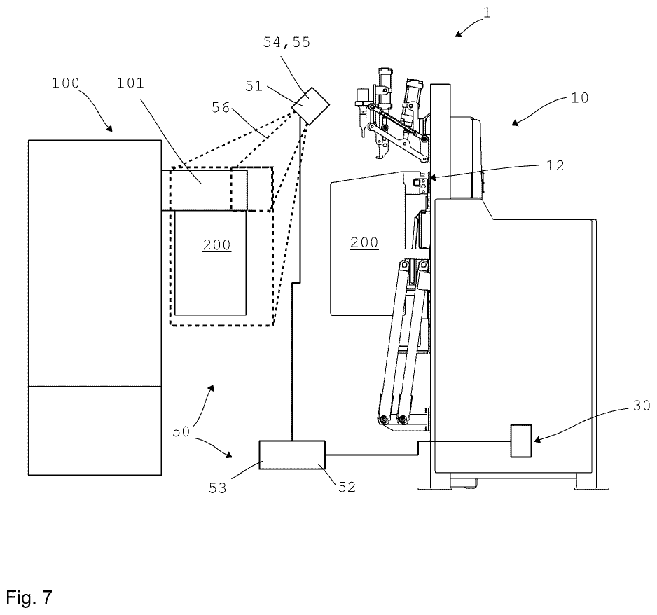

FIG. 7 a purely schematic representation of a further example of embodiment of a system according to the invention in a view from the side.

FIG. 1 shows a purely schematic example of embodiment of a system 1 according to the invention, wherein system 1 according to the invention in the example of embodiment shown here comprises a packaging machine 10, a control device 30 and a monitoring device 50.

In the example of embodiment shown here, control device 30 is included in packaging machine 10 or control device 30 controls packaging machine 10 or the filling process in the example of embodiment shown.

In the example of embodiment example shown here, packaging machine 10 is designed as a so-called single-spout packing machine, which comprises only one filling module 11 with a single filling spout 12.

In the example of the embodiment shown, empty bags or bags 200 or valve bags here can be attached to this filling spout 12 and then filled with a flowable and/or free-flowing bulk material.

In the example of embodiment example shown, monitoring device 50 comprises a sensor device 51 and a computing device 52. In the example of embodiment shown, computing device 52 comprises a computer 53, wherein computing device 52 or computer 53 is connected to the Internet, i.e. is online, as indicated here in the example of embodiment shown.

In the shown example of embodiment, sensor device 51 comprises a camera device 54, which is provided here by a conventional webcam 55.

However, in other examples of embodiment not shown, the packaging machine 10 can also comprise a plurality of filling modules 11, which depending on the design can also be assigned to a rotating packaging machine. Also with such an embodiment, only one monitoring device 50 with only one sensor device 51 and only one computing device 52 can be provided. However, a plurality of monitoring devices 50, sensor devices 51 and/or computing devices 52 can also be provided.

FIG. 2 indicates an example of application of the inventive system according to FIG. 1 in a purely schematic way. In the example of embodiment shown, monitoring device 50 is intended to check whether a bag 200 leaks when bag 200 is filled, which is detected by a dust cloud or dust generation in a certain area.

For this purpose, detection area 56 of sensor device 51 or in this case camera device 54 is selected in such a way that only the relevant image section is recorded and/or viewed or used. Detection area 56 can actually be a detection area 56 of the camera or a software-selected image section of sensor device 51 or camera device 54.

FIG. 3 shows purely schematically that a leakage of bag 200 has occurred during filling or that the bag is generally leaking. This creates a dust cloud in the upper area of detection area 56.

Through the automated application or through the use of artificial intelligence or computer vision, such a bag leak can be detected in an extremely short time, so that control device 30 can stop the filling process by the event detected by monitoring device 50, e.g. a bag breakage or bag leakage. Compared to conventional methods, the filling process can thus be stopped much faster.

FIG. 4 shows that a bag leak can occur in various places and can also be detected. This can also be detected depending on the training of the automated application or the AI application or the computer vision application.

FIG. 5 shows a similar example of embodiment to FIG. 1, wherein a similar case of application is shown here. In the example of embodiment shown here, detection area 56 of sensor device 51 or camera device 54 is focused on the upper area of bag 200 to be filled.

FIG. 6 shows another example of application for monitoring an area of a packaging machine 10 by means of an automated application or by means of an AI application or by means of a computer vision application, which are executed on a monitoring device 50 or on computing device 52 of a monitoring device 50.

Here, the area of the filling spout 11 is monitored, so that the correct fit of the bag on the filling spout can be monitored, depending on the training of the automated application or the AI application or the computer vision application.

FIG. 7 again shows purely schematically the example of embodiment according to FIG. 6, wherein another case of application is shown here.

In this case, detection area 56 is selected in such a way that an automatic bag applicator 100 installed adjacent to the packing machine 10 is detected. Bag applicator 100 is then preferably also part of system 1.

In the application shown here, it can be checked, for example, whether the valve of a bag 200 is correctly opened in chute channel 101 and/or whether the correct type of bag is provided by the bag applicator 100.

The other applications mentioned in the description and many others can also be monitored by means of an automated application or by means of an AI application or a computer vision application.

### LIST OF REFERENCE NUMBERS

1 system
10 packing machine
11 filling module
12 filling spout
30 control device
50 monitoring device
51 sensor device
52 computing device
53 computer
54 camera device
55 webcam
56 detection area
100 bag applicator
101 chute channel
200 bag

1. A system comprising: at least one packaging machine; at least one control device; and at least one monitoring device;
wherein the monitoring device comprises at least one sensor device and at least one computing device;
and wherein the packaging machine comprises at least one filling module with at least one filling spout;
the sensor device comprises at least one camera device; and the computing device is suitable and designed to check the image data recorded by the camera device by means of an evaluation based on at least one automated application on predetermined events; wherein the automated application comprises at least one AI application and/or at least one computer vision application.

2. The system according to claim 1, wherein the evaluation of the automated application is transferable to the control device.

3. The system according to claim 1, wherein the sensor device is assigned to the filling module.

4. The system according to claim 1, wherein the control device is suitable and equipped to detect at least one of a leakage of a bag during filling, whether a bag to be filled is correctly attached to the filling spout, whether a filled bag has been correctly closed, which type of bag is used for filling and whether the bag is correctly opened for attachment.

5. A method of operating a system according to claim 1,
characterised in that:
based on the evaluation of the image data from the camera device of the sensor device with the aid of the automated application, the monitoring device determines that there is a specific event and a correspondingly predetermined action is then initiated, wherein the automated application includes at least one of at least one AI application and at least one computer vision application.

6. The method according to claim 5, wherein the automated application checks the data online.

7. The method according to claim 5, wherein the automated application is trained and/or operates offline on the computing device.

8. The method according to claim 5, wherein the automated application is retrained.

9. The method according to claim 5, wherein at least one of the leakage of a bag is detected during filling, wherein it is detected whether a bag to be filled is correctly attached to the filling spout, wherein it is detected whether a filled bag has been correctly closed, wherein it is detected which type of bag is used for filling and whether the bag is correctly opened for attachment.

10. A use of an automated application comprising at least one of at least one AI application and at least one computer vision application, in the monitoring of events on a packaging machine based on image data from at least one camera device of at least one sensor device.

11. The use according to claim 10, utilizing a system comprising: at least one packaging machine: at least one control device; and at least one monitoring device; wherein the monitoring device comprises at least one sensor device and at least one computing device;
and wherein the packaging machine comprises at least one filling module with at least one filling spout;
the sensor device comprises at least one camera device; and the computing device is suitable and designed to check the image data recorded by the camera device by means of an evaluation based on at least one automated application on predetermined events; wherein the automated application comprises at least one of at least one AI application and at least one computer vision application.

12. The use according to claim 10, wherein at least one of the leakage of a bag during filling is detected as an event, wherein it is detected whether a bag to be filled is correctly attached to the filling spout, wherein it is detected whether a filled bag has been correctly closed, wherein it is detected which type of bag is used for filling and whether the bag is correctly opened for attachment.
